(19) United States
(12) Patent Application Publication
(10) Pub. No.: US 2015/0138579 A1
(43) Pub. Date: May 21, 2015

(54) MAINTENANCE METHOD AND MAINTENANCE APPARATUS FOR INFORMATION PROCESSING APPARATUS

(71) Applicants: TOSHIBA TEC KABUSHIKI KAISHA, Tokyo (JP); KABUSHIKI KAISHA TOSHIBA, Tokyo (JP)

(72) Inventors: Sou Miyazaki, Kanagawa-ken (JP); Yoshikatsu Kamisuwa, Tokyo-to (JP); Masaki Narahashi, Tokyo-to (JP); Reiji Murakami, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/081,250

(22) Filed: Nov. 15, 2013

(51) Int. Cl. H04N 1/00; G06Q 20/20; G06K 15/12

(52) U.S. Cl. CPC H04N 1/00973; G06K 15/12; G06Q 20/209; H04N 1/00411; H04N 2201/0094
USPC 358/1.13

(57) ABSTRACT

In accordance with one embodiment, a maintenance method for an information processing apparatus includes acquiring setting value information of setting items of a specific information processing apparatus to be maintained; selecting the information processing apparatuses belonging to a preset group and calculating a superior apparatus with the lowest fault rate from the information processing apparatuses belonging to the group through a processor based on machine information; acquiring setting value information of setting items of the superior apparatus through the processor; and prompting the setting value information of the superior apparatus as reference information in such a manner that the setting value information of the superior apparatus is comparable to that of the specific information processing apparatus.

### FIELD

Embodiments described herein relate to a maintenance method and a maintenance apparatus for analyzing an information processing apparatus such as an image forming apparatus or a POS (point of sales) terminal.

### BACKGROUND

Conventionally, an image forming apparatus such as an electrophotographic type copier forms an image on a sheet and the like through a cycle of charging, exposure, developing, transfer and fixing. Moreover, the image forming apparatus is maintained by a service man, who is informed of the occurrence of an abnormality in the image forming apparatus by the user through telephone when the abnormality occurs and then goes to the place where the apparatus is installed to confirm the condition.

Further, in the case of periodic inspection or service call, the service man goes to the place where the image forming apparatus is installed and carries out a maintenance and inspection operation while confirming the state of the image forming apparatus with a maintenance apparatus. The serviceman can change the setting of the machine to be different from the state at time of factory shipment matching with the use frequency or the use purpose, the usage environment and the individual difference of the machine. The setting of the machine refers to, for example, a scanning position, the margin of a sheet, the rotation speed of a sheet conveying motor and the like.

In order to lower the occurrence rate of faults, the service man needs to adjust the setting values of the setting items of each machine to optimal setting values. However, each kind of machines has a great variety of setting items, and the optimal values of which change in different machines, thus, it is difficult to set optimal values.

### BRIEF DESCRIPTION OF THE DRAWINGS

FIG. 1 is a block diagram illustrating an example of the constitution of a maintenance apparatus according to an embodiment;

FIG. 2 is an external view illustrating the relation between an image forming apparatus and a maintenance apparatus according to an embodiment;

FIG. 3 is an illustration diagram illustrating the relation between an image forming apparatus and a server according to an embodiment;

FIG. 4 is an illustration diagram illustrating an example of a machine information table of a maintenance apparatus according to an embodiment;

FIG. 5 is an illustration diagram illustrating an example of an error information table of a maintenance apparatus according to an embodiment;

FIG. 6 is an illustration diagram illustrating an example of a machine setting table of a maintenance apparatus according to an embodiment;

FIG. 7 is a flowchart illustrating operations of a maintenance apparatus according to an embodiment;

FIG. 8 is a flowchart illustrating operations of calculating a machine with the lowest fault rate according to an embodiment;

FIG. 9 is an illustration diagram illustrating an example of a comparison table displayed on a display section according to an embodiment; and

FIG. 10 is an illustration diagram illustrating another example of a comparison table displayed on a display section according to an embodiment.

### DETAILED DESCRIPTION

In accordance with one embodiment, a maintenance method for an information processing apparatus includes acquiring setting value information of setting item of a specific information processing apparatus to be maintained, selecting the information processing apparatuses belonging to a preset group and calculating a superior apparatus with the lowest fault rate from the information processing apparatuses belonging to the group through a processor based on machine information; acquiring setting value information of setting items of the superior apparatus through the processor; and prompting the setting value information of the superior apparatus as reference information in such a manner that the setting value information of the superior apparatus is comparable to that of the specific information processing apparatus.

A maintenance apparatus for an information processing apparatus according to embodiment 1 is described in detail below with reference to accompanying drawings, in which the same reference symbol denotes the same component.

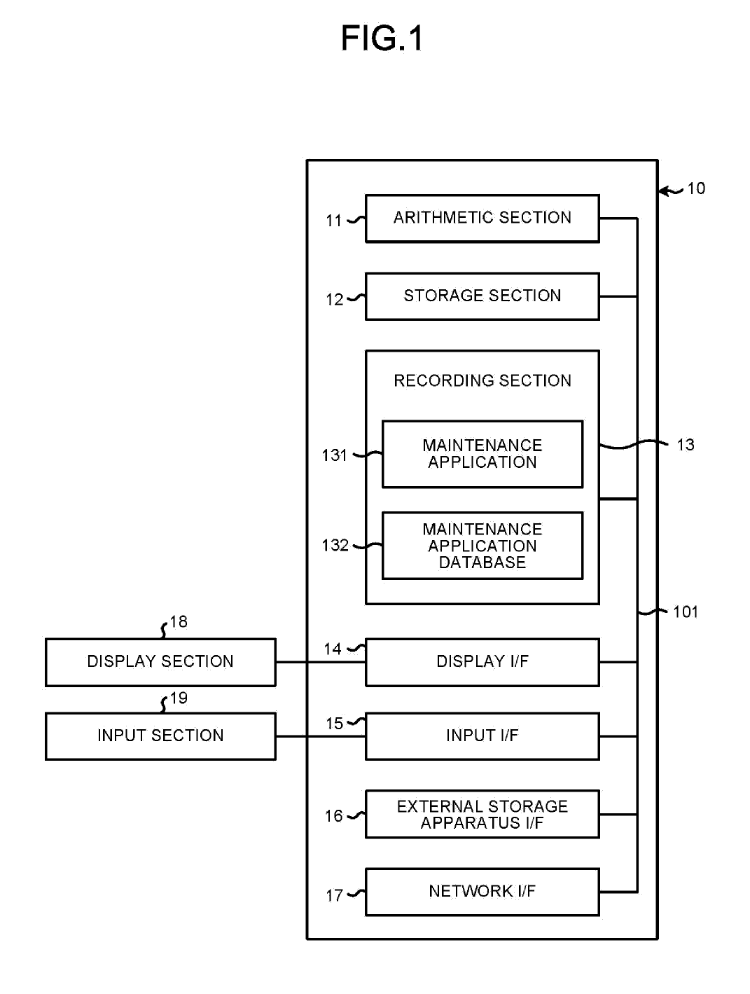

FIG. 1 is a block diagram illustrating an example of constitution of a maintenance apparatus 10 according to embodiment 1. As shown in FIG. 1, the maintenance apparatus 10 comprises an arithmetic section 11 such as a processor provided with a CPU, a storage section 12 such as a memory, a recording section 13 such as a HDD, a display interface (I/F) 14, an input interface (I/F) 15, an external storage apparatus interface (I/F) 16 and a network interface (I/F) 17. Further, the arithmetic section 11, the storage section 12, the recording section 13, the display I/F 14, the input I/F 15, the external storage apparatus I/F 16 and the network I/F 17 are connected with each other through a bus line 101.

The display I/F 14 is connected with a display section 18 such as a liquid crystal display to provide image information for the display section 18. Further, the input I/F 15 is connected with an input section 19 provided with a mouse and a keyboard and the like to send an instruction input from the input section 19 to the arithmetic section 11. The external storage apparatus I/F 16 is an interface with an external storage apparatus, which is, for example, a detachable external storage medium such as a USB (Universal Serial Bus) memory. Further, the network I/F 17 is an interface communicating with a network 100 (FIG. 3) such as an Internet.

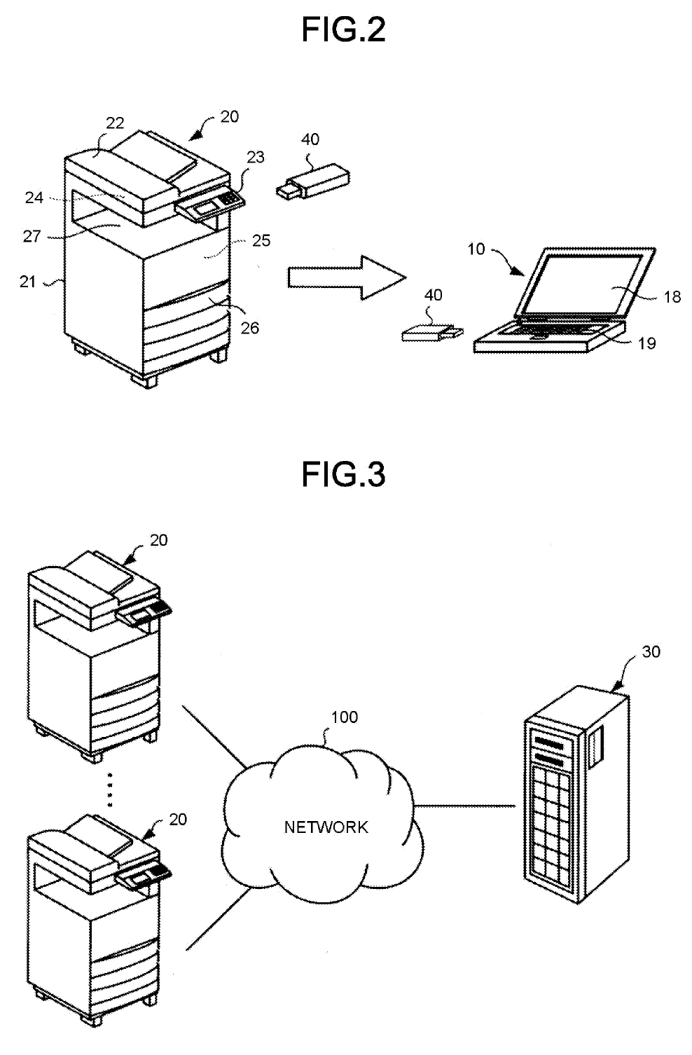

On the premise that the maintenance apparatus 10 is carried by a service man to the place where an image forming apparatus is arranged, the maintenance apparatus 10 is preferred to be in a carriageable form such as a form equivalent to a personal notebook computer shown in FIG. 2 or a tablet terminal.

Moreover, in embodiment 1, as shown in FIG. 2, the setting value information of an image forming apparatus 20 may also be provided to the maintenance apparatus 10 through a detachable external storage medium such as a USB (Universal Serial Bus) memory 40 in an offline manner, in addition to through the network 100 in an online manner.

In addition, in the following description, the image forming apparatus 20 is exemplarily described as an information processing apparatus, which, however, may also be a POS (point of sale) terminal. Furthermore, a compound machine, that is, a MFP, is exemplarily described as the image forming apparatus 20, which, however, may also be other image forming apparatus such as a copier, a printer, a scanner, a fax machine and the like.

FIG. 2 is an external view illustrating the relation between the MFP 20 (image forming apparatus) and the maintenance apparatus 10. A document table, on which an automatic document feeder (ADF) 22 is arranged in an openable/closable manner, is arranged on the upper portion of a main body 21 of the MFP 20. Further, an operation section 23 is arranged on the upper portion of the main body 21. The operation section 23 is provided with various operation keys and a touch panel type display section.

Further, a scanner section 24 is arranged under the ADF 22 in the main body 21. The scanner section 24 reads the document fed by the ADF 22 or placed on the document table to generate image data. A printer section 25 is arranged in the internal center of the main body 21, and a plurality of cassettes 26 for accommodating papers of different sizes are arranged on a lower portion of the main body 21.

The printer section 25 comprises a photoconductive drum and laser to process the image data read by the scanner section 24 and the image data created by a PC (Personal Computer) and the like to form and fix an image on a sheet. The sheet on which an image is fixed by the printer section 25 is discharged to a paper discharge section 27.

Further, a port for connecting a detachable USB memory 40 serving as an external storage apparatus is arranged on a lateral side of the main body 21 of the MFP 20. By connecting the USB memory 40 with the port of the MFP 20, various kinds of information such as the machine information of the MFP 20 can be acquired and stored in the USB memory 40.

Further, the maintenance apparatus 10 is also provided with a port for connecting the USB memory 40. The maintenance apparatus 10 can acquire the various kinds of information of the MFP 20 stored in the USB memory 40 through the external storage apparatus I/F 16. Machine information containing log data is stored in the USB memory 40.

FIG. 3 is an illustration diagram illustrating the relation between the MFP (image forming apparatus) 20 and a server 30. As shown in FIG. 3, one or more MFPs 20 are connected with the network 100 which is connected with a server 30 for carrying out information analysis. When the MFP 20 is connected with the network 100, the server 30 automatically collects and stores machine information containing the setting value information of the MFP 20. The maintenance apparatus 10 acquires various data from the server 30 via the network 100 and the network I/F 17.

Moreover, a maintenance application 131 (hereinafter referred to as ‘application’) for the use by the image forming apparatus and a maintenance application database 132 (hereinafter referred to as ‘database’) are stored in the recording section 13 of the maintenance apparatus 10 according to embodiment 1. Various processing based on the application 131 is executed by the arithmetic section 11. Further, the machine information (which will be described later) created by the server 30 can be downloaded and stored in the database 132. Moreover, no specific limitation is given to the database 132 as long as the database 132 can store and read data.

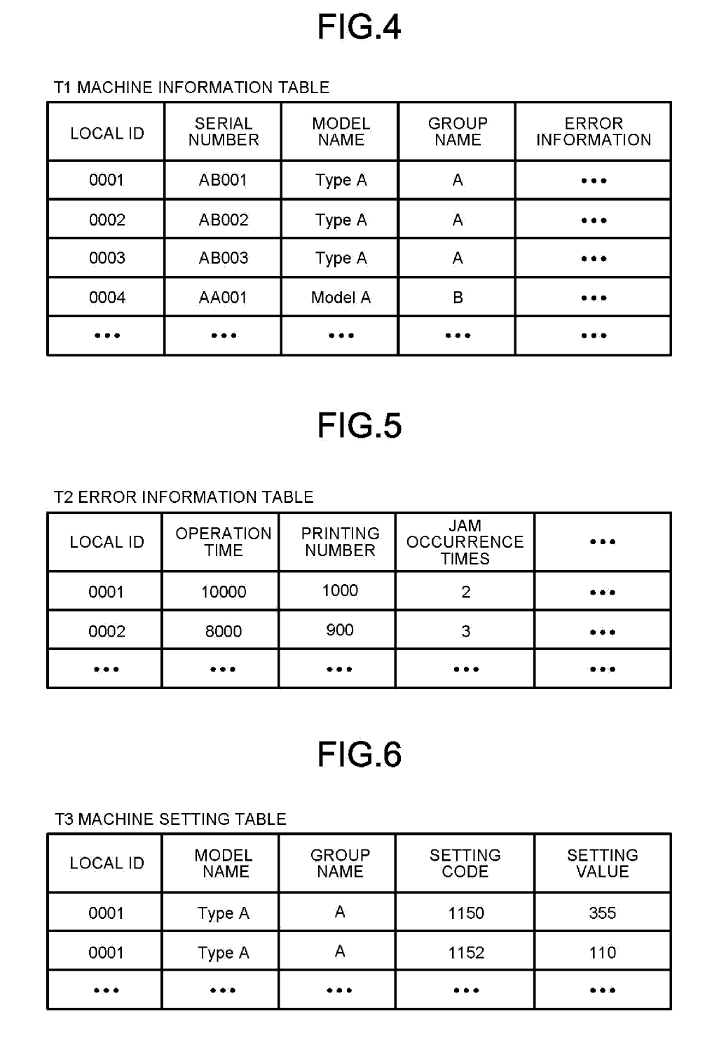

The machine information stored in the database 132 consists of, for example, a machine information table T1 (FIG. 4), an error information table T2 (FIG. 5), a machine setting table T3 (FIG. 6) and the like.

As shown in FIG. 4, the machine information table T1 consists of columns of ‘local ID’, ‘serial number’, ‘model name’, ‘group name’ and ‘error information’ of the MFP 20. That is, machine information consisting of a local ID serving as a reference number in the machine information table T1, a serial number assigned from a maker serving as a fixed identification number of a machine, a model number representing a machine type, a group name for distinguishing machines by a specific group, for example, machines of the same type or machines on the same floor, and error information are stored.

Moreover, as shown in FIG. 5, the error information table T2 consists of columns of ‘local ID’, ‘operation time’, ‘printing number’, ‘Jam occurrence times’ of the MFP 20. That is, the error information table T2 includes a local ID serving as a reference number in the error information table T2, an operation time indicating the operation time of a machine, a printing number indicating the total printing number or the printing number in one day of a machine, and the Jam occurrence times indicating the times of paper jams occurred in a machine.

Further, as shown in FIG. 6, the machine setting table T3 consists of columns of a local ID serving as a reference number in the machine setting table T3, a model name representing a machine type, a group name, a setting code serving as a code assigned to a setting item of the MFP 20 and a setting value serving as a value assigned to a setting item.

Further, the setting items of the MFP 20 include setting items relating to process, setting items relating to scanner, setting items relating to printer and setting items relating to system. For example, the setting items relating to process include a primary transfer voltage, a secondary transfer voltage, a primary transfer current and a secondary transfer current. Further, the setting items relating to printer include the speed of a drum motor, the speed of a transfer belt motor, the speed of a paper feed motor and the speed of a fixing and paper discharging motor.

The present embodiment relates to a coping method for adjusting a setting item becoming the reason of a fault to an optimal setting value in a case where a fault occurs in a specific machine. That is, setting values of the machine with the lowest fault rate are prompted as reference information based on the machine information of other MFPs 20 connected with the network 100, and displayed as a guide for a setting value adjustment. Additionally, the ‘machine’ refers to the image forming apparatus 20, which consists of a MFP, a printer, a scanner, a fax machine and the like. Besides, the machine with the lowest fault rate is referred hereinafter to as a superior apparatus.

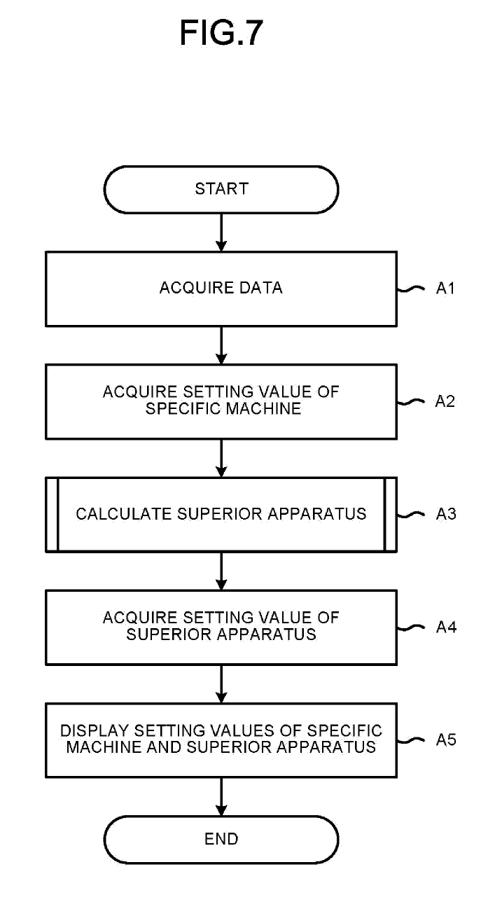

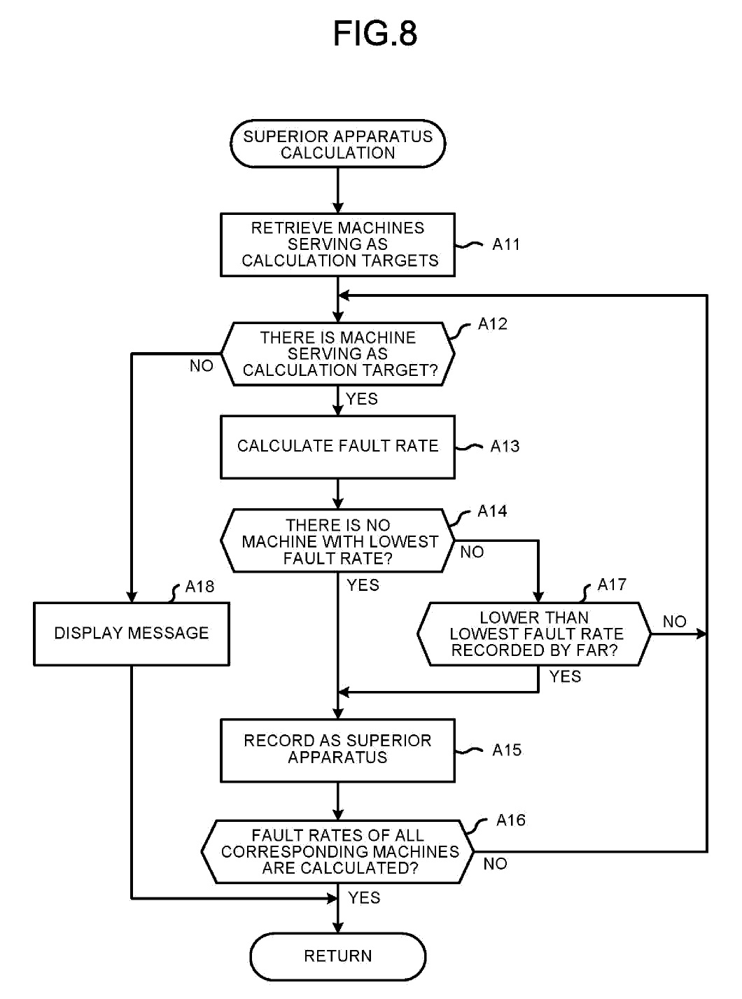

The operations of the maintenance apparatus 10 according to the embodiment are described below with reference to the flowcharts in FIG. 7 and FIG. 8. For the sake of convenience, the arithmetic section 11 is referred to as a CPU 11. Further, a specific information processing apparatus, in which a fault occurs, needing maintaining is referred to as a ‘specific machine’. Further, the maintenance apparatus 10 is set to be connected with the server 30 through the network 100.

In FIG. 7, if an operator such as a service man operates a specific machine to input an instruction of displaying setting values, the CPU 11 receives an application activation command. The CPU 11 expands the application 131 in the storage section 12 and makes the application 131 in an executable state (start). The application 131 is in an executable state in the following description unless otherwise noted, and the programs in the application 131 are executed by the CPU 11.

In ACT A1, the CPU 11 acquires the pre-defined machine information from the USB memory 40 through the external storage apparatus I/F 16 in a pre-defined manner and stores the machine information in the database 132. The external storage apparatus I/F 16 constitutes an acquisition section for acquiring the setting value information of the specific machine. The machine information contains log data which is stored in such a manner that the log data can be acquired according to attributions such as a machine type, a machine number, a customer name and an installation site.

In ACT A2, the CPU 11 acquires designated data from the database 132. Herein, the setting value of each setting item of the specific machine is acquired.

Next, in ACT A3, the CPU 11 calculates the machine with the lowest fault rate (which will be described later) from a plurality of machines meeting a calculation target condition. Further, the details of ACT A3 are described below in the flowchart of FIG. 8 which illustrates the calculation of a fault rate. As to calculation targets, for example, in a plurality of MFPs 20 connected with the network 100, the machines belonging to the same group are taken as calculation targets. As to the calculation of a fault rate, the setting value data of the MFPs 20 belonging to the same group are read from the server 30 to calculate a fault rate.

Besides, the fault rate is calculated using a general fault rate (1/MTBF). MTBF (Mean Time Between Failure) refers to the mean time between the failures occurring in a system. In addition to 1/MTBF, any index deemed important by the user may also be acquired, such as an accumulated fault times or an accumulated call occurrence times. In the present embodiment, for the sake of convenience, an example is described in which an index which is preferred to be as small as possible such as 1/MTBF is used. In this way, the superior apparatus with the lowest fault rate is calculated from machines meeting a predetermined condition (e.g. belonging to the same machine type).

Next, the CPU 11 acquires setting values of the superior apparatus in ACT A4. Then, in ACT A5, the CPU 11 prompts the setting values of the specific machine and the setting values of the superior apparatus on the display section 18 via the display I/F 14. That is, the CPU 11 and the display I/F 14 constitute a prompting section which prompts the setting value information of the superior apparatus as reference information in such a manner that the setting value information of the superior apparatus is comparable to that of the specific information processing apparatus.

By displaying the setting values of the two machines in rows on the display section 18, it is easy to compare values. Further, a fault rate calculated earlier may also be displayed as reference.

FIG. 8 is a flowchart illustrating, in detail, the superior apparatus calculation of ACT A3 shown in FIG. 7. In ACT A11, the CPU 11 receiving a setting value display instruction retrieves, from the server 30, the MFPs 20 belonging to the same group (e.g. the same machine type) serving as calculation targets and stores the machine information of corresponding MFPs 20 in the database 132.

Next, the CPU 11 determines whether or not there is a machine meeting a predetermined condition in ACT A12. If the CPU 11 determines that there is a machine meeting the predetermined condition (YES in ACT A12), the flow proceeds to ACT A13 in which the CPU 11 calculates the fault rate of a first machine meeting the condition.

In ACT A14, whether or not there is no machine with the lowest fault rate is determined. If there is no machine with the lowest fault rate (YES in ACT A14), the flow proceeds to ACT A15 in which the machine calculated in ACT A13 is recorded in the database 132 as the machine with the lowest fault rate, that is, the superior apparatus. In this case, as it is only needed to store the superior apparatus temporarily, the superior apparatus may be stored in a given memory.

In the following ACT A16, whether or not the fault rates of all corresponding machines are calculated is determined. The process is ended if the fault rates of all corresponding machines are calculated (YES in ACT A16). On the other hand, if there is a machine the fault rate of which is not calculated (NO in ACT A16), the CPU 11 returns to ACT A12 to calculate the fault rate of the rest calculation target machines.

Further, in ACT A14, if the machine with the lowest fault rate exists (NO in ACT A14), the CPU 11 proceeds to ACT A17 in which the CPU 11 determines whether or not the fault rate calculated in ACT A13 is lower than the lowest fault rate recorded by far. If the fault rate calculated in ACT A13 is lower than the lowest fault rate recorded by far (YES in ACT A17), the CPU 11 records (updates) the machine having the fault rate calculated in ACT A13 as a machine with the lowest fault rate (superior apparatus) in ACT A15.

On the other hand, if the fault rate calculated in ACT A13 is greater than the lowest fault rate recorded by far (NO in A17), the CPU 11 returns to ACT A12 to repeat the same processing until the fault rates of all calculation target machines are calculated, thereby calculating the fault rate of each machine to calculate the superior apparatus.

Further, if it is determined in ACT A12 that there is no machine meeting the predetermined condition (NO in ACT A12), the CPU 11 displays a message on the display section 18 in ACT A18 and then ends the processing. The message may be, for example, ‘no machine meeting the condition, input another condition please’.

After the superior apparatus is calculated, setting values of the specific machine and the superior apparatus are comparably displayed on the display section 18 via the processing in ACT A4 and ACT A5 shown in FIG. 7.

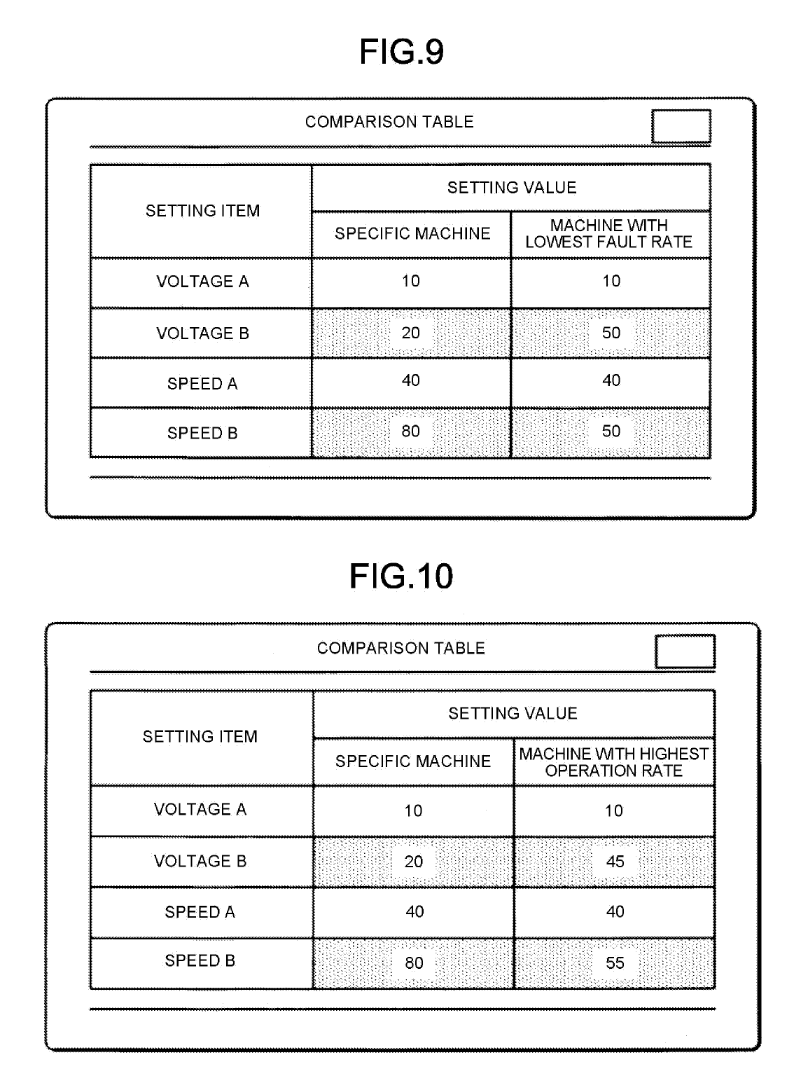

FIG. 9 is an example of a comparison table displayed on the display section 18. In the comparison table, for example, setting items of the specific machine, setting values of the specific machine and setting values of the machine with the lowest fault rate (superior apparatus) are displayed in rows.

Thus, by comparing the items in which the setting values of the specific machine and the machine with the lowest fault rate are significantly different, the operator is aware of how to set the setting values of the specific machine. That is, it is highly likely to avoid a fault by adjusting the setting values of the specific machine to be values closer to the setting values of the superior apparatus.

In FIG. 9, a voltage A, a voltage B, a speed A and a speed B are exemplarily shown in FIG. 9 as setting items, and it is exemplified that in the items of the voltage B and the speed B, the setting values of the specific machine are significantly different from those of the machine with the lowest fault rate.

If it can be predicted that fault occurs in which part of the specific machine, the setting value of the predicted item, such as a setting item relating to scanner or a setting item relating to printer, is selected and displayed in the comparison table. Further, the position of a fault may be specified based on the log data of the specific machine. For example, the position of a fault may be specified based on the error information shown in FIG. 5.

Further, it is exemplifies that in order to calculate a machine which barely has fault, the fault rate is calculated to calculate a machine with the lowest fault rate, and the reference information serving as an index is prompted; however, it is not limited to calculating the lowest fault rate, and any modification may be made. For example, ‘operation rate’ may be calculated instead of the lowest fault rate. The operation rate may be calculated using the operation time shown in FIG. 5. A machine with high operation rate is considered as a machine barely has fault, that is, a superior apparatus since the time when the machine stops operating due to a fault is short.

FIG. 10 illustrates another example of the comparison table displayed on the display section 18. In the comparison table, for example, setting items of the specific machine, setting values of the specific machine and setting values of the machine with the highest operation rate (superior apparatus) are displayed in rows. In FIG. 10, it is exemplified that in items of ‘voltage B’ and ‘speed B’, the setting values of the specific machine are significantly different from those of the machine with the highest operation rate.

Further, a machine with the least accumulated fault times or a machine with the least accumulated call times may also be calculated instead of a machine with the lowest fault rate. The jam occurrence times shown in FIG. 5 may be listed as an accumulated fault times. Further, the accumulated call times refer to the number of times of the service man call, and it can be considered that the less these times are, the less the faults are.

Further, the ‘predetermined condition’ for determining a machine to be a fault rate calculation target is not limited to be ‘the same machine type’, it may also be modified properly. For example, the condition may also be the installation site of the machines such as the machines arranged in the same floor. Further, the condition may be the machines produced at the same time, the machines under the same contract or the machines having the same printing numbers.

Further, an image forming apparatus is described herein as a machine to be maintained, however, the target maintained by the maintenance apparatus 10 is not limited to the image forming apparatus. For example, the maintenance apparatus may also maintain various information processing apparatuses such as a POS (Point Of Sale) installed in a business facility.

As stated above, in the maintenance apparatus 10 according to an embodiment, setting values, with which the occurrence times of a fault can be reduced, can be prompted to the operator such as a service man as reference information. Thus, the operation time taken to avoid a fault can be shortened.

Besides, the processing shown in embodiments described herein may also be realized by hardware or by an application (computer program) which is stored in a memory such as the recording section 13 and executed by the arithmetic section 11 such as a CPU.

Further, in embodiments described herein, the maintenance apparatus 10 may consist of a single PC or a PC and the server 30. For example, the server 30 may have part of the functions of a PC, and various processing results may be displayed on the PC using the information from the server 30.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A maintenance method for an information processing apparatus, including:
acquiring setting value information of setting items of a specific information processing apparatus to be maintained;
selecting information processing apparatuses belonging to a preset group and calculating a superior apparatus with the lowest fault rate from the information processing apparatuses belonging to the group through a processor based on machine information;
acquiring setting value information of setting items of the superior apparatus through the processor; and
prompting the setting value information of the superior apparatus as reference information in such a manner that the setting value information of the superior apparatus is comparable to that of the specific information processing apparatus.

2. The maintenance method for an information processing apparatus according to claim 1, further including:
calculating fault rates of the information processing apparatuses belonging to the group, and calculating the information processing apparatus with the lowest fault rate as the superior apparatus; and
prompting the setting value information of the information processing apparatus with the lowest fault rate as the reference information.

3. The maintenance method for an information processing apparatus according to claim 1, further including:
calculating operation rates of the information processing apparatuses belonging to the group, and calculating the information processing apparatus with the highest operation rate as the superior apparatus; and
prompting the setting value information of the information processing apparatus with the highest operation rate as the reference information.

4. The maintenance method for an information processing apparatus according to claim 1, wherein
the information processing apparatuses belonging to the preset group are information processing apparatuses belonging to the same machine type.

5. The maintenance method for an information processing apparatus according to claim 1, further including:
specifying occurrence position of a fault based on log data of the specific information processing apparatus, and prompting the setting value information of a setting item corresponding to the occurrence position of the fault and the setting value information of the same setting item of the superior apparatus as reference information.

6. A maintenance apparatus for an information processing apparatus, comprising:
an acquisition section configured to acquire setting value information of setting items of a specific information processing apparatus to be maintained;
an arithmetic section configured to select information processing apparatuses belonging to a preset group, calculate a superior apparatus with the lowest fault rate from the information processing apparatuses belonging to the group based on machine information, and acquire the setting value information of the setting items of the superior apparatus;
a prompting section configured to prompt the setting value information of the superior apparatus as reference information in such a manner that the setting value information of the superior apparatus is comparable to that of the specific information processing apparatus; and
a display section configured to display the information from the prompting section.

7. The maintenance apparatus for an information processing apparatus according to claim 6, wherein
the arithmetic section calculates fault rates of the information processing apparatuses belonging to the group and calculates the information processing apparatus with the lowest fault rate as the superior apparatus; and
the prompting section prompts the setting value information of the information processing apparatus with the lowest fault rate as the reference information.

8. The maintenance apparatus for an information processing apparatus according to claim 6, wherein
the arithmetic section calculates operation rates of the information processing apparatuses belonging to the group and calculates the information processing apparatus with the highest operation rate as the superior apparatus; and
the prompting section prompts the setting value information of the information processing apparatus with the highest operation rate as the reference information.

9. The maintenance apparatus for an information processing apparatus according to claim 7, wherein
the operation section acquires the setting value information of the setting items of the information processing apparatuses belonging to the same machine type to calculate the superior apparatus.

10. The maintenance apparatus for an information processing apparatus according to claim 6, wherein
the prompting section specifies occurrence position of a fault based on log data of the specific information processing apparatus and prompts the setting value information of a setting item corresponding to the occurrence position of the fault and the setting value information of the same setting item of the superior apparatus as reference information.
